(19) United States
(12) Patent Application Publication
(10) Pub. No.: US 2012/0250144 A1
(43) Pub. Date: Oct. 4, 2012

(54) REFLECTIVE OPTICAL ELEMENT AND METHOD FOR OPERATING AN EUV LITHOGRAPHY APPARATUS

(75) Inventors: Dirk Heinrich EHM, Lauchheim (DE); Axel DOCHNAHL, Rosenberg (DE); Gisela VON BLANCKENHAGEN, Aalen (DE)

(73) Assignee: CARL ZEISS SMT GMBH, Oberkochen (DE)

(21) Appl. No.: 13/436,338

(22) Filed: Mar. 30, 2012

Related U.S. Application Data
(63) Continuation of application No. PCT/EP2010/063694, filed on Sep. 17, 2010.
(60) Provisional application No. 61/247,269, filed on Sep. 30, 2009.

(30) Foreign Application Priority Data
Sep. 30, 2009 (DE) 10 2009 045 170.6

(51) Int. Cl. G02B 5/08

(52) U.S. Cl. 359/360

(57) ABSTRACT

In order to reduce the adverse influence of contamination composed of silicon dioxide, hydrocarbons and/or metals within an EUV lithography apparatus on the reflectivity, a reflective optical element (50) for the extreme ultraviolet wavelength range having a reflective surface (59) is proposed, wherein the multilayer coating of the reflective surface (59) has a topmost layer (56) composed of a fluoride. The contaminations mentioned, which deposit on the reflective optical element (50) during the operation of the EUV lithography apparatus, are converted into volatile compounds by the addition of at least one of the substances mentioned hereinafter: atomic hydrogen, molecular hydrogen, perfluorinated alkanes such as e.g. tetrafluoromethane, oxygen, nitrogen and/or helium.

This application is a Continuation of International Application No. PCT/EP2010/063694, filed on Sep. 17, 2010, which claims the benefit of U.S. Provisional Application No. 61/247,269, filed Sep. 30, 2009, and also claims the priority of German Application No. 2009 045 170.6, also filed on Sep. 30, 2009. The entire disclosures of all three of these applications are hereby incorporated into the present Continuation Application by reference.

### FIELD AND BACKGROUND

The present invention relates to a reflective optical element for the extreme ultraviolet (EUV) wavelength range having a reflective surface. Moreover, the present invention relates to a method for operating an EUV lithography apparatus comprising a reflective optical element having a reflective surface. Furthermore, the present invention relates to an EUV lithography apparatus comprising a reflective optical element, to an illumination system, in particular for an EUV lithography apparatus, comprising a reflective optical element, and to a projection system, in particular for an EUV lithography apparatus, comprising a reflective optical element.

In EUV lithography apparatuses, reflective optical elements for the extreme ultraviolet (EUV) wavelength range (e.g. wavelengths of between approximately 5 nm and 20 nm) in the form of photomasks or multilayer mirrors are used for the lithographic imaging of semiconductor components. Since EUV lithography apparatuses generally have a plurality of reflective optical elements, the latter have to have a highest possible reflectivity in order to ensure a sufficiently high total reflectivity. The reflectivity and the lifetime of the reflective optical elements can be reduced by contamination of the optically used reflective surface of the reflective optical elements, which arises on account of the short-wave irradiation together with residual gases in the operating atmosphere. Since a plurality of reflective optical elements are usually arranged one behind another in an EUV lithography apparatus, even relatively small contaminations on each individual reflective optical element affect the total reflectivity to a relatively large extent.

Contamination can occur on account of moisture residues, for example. In this case, water molecules are dissociated by the EUV radiation and the resulting free oxygen radicals oxidize the optically active surfaces of the reflective optical elements. In this case, an optically active surface is defined as the optically used region of the surface of the optical element.

A further source of contamination is polymers, in particular hydrocarbons, which can originate for example from the materials used in the vacuum environment or from the vacuum pumps used in EUV lithography apparatuses, or from residues of photoresists which are used on the semiconductor substrates to be patterned, and which lead, under the influence of the operating radiation, to carbon contaminations on the reflective optical elements. Attempts are made to combat these types of contamination firstly by targeted setting of the residual gas atmosphere within the EUV lithography apparatuses and secondly by protective layers on the optically active surfaces of the reflective optical elements.

Oxidative contaminations and carbon contaminations can generally be removed, inter alia, by treatment with atomic hydrogen, by the atomic hydrogen reducing the oxidative contaminants or reacting with the carbon-containing residues to form volatile compounds. Atomic hydrogen can form under the influence of the operating radiation within the EUV lithography apparatus as a result of the dissociation of molecular hydrogen. However, preference is given to using cleaning units wherein molecular hydrogen is dissociated into atomic hydrogen e.g. at an incandescent filament. This is because they allow the amount of atomic hydrogen to be controlled and the atomic hydrogen to be introduced into the EUV lithography apparatus as closely as possible to the optically active surfaces to be cleaned of the reflective optical elements.

It has been found, however, that the cleaning units can also lead to contaminations in particular by metals which originate predominantly from the cleaning units themselves or, in chemical reaction with the atomic hydrogen, are extracted from materials or components within EUV lithography apparatuses, in particular as volatile metal hydrides.

Furthermore, it has been found that contaminations in the form of silicon compounds in interaction with EUV radiation lead to contamination layers composed of silicon dioxide (SiO₂) on the optically active surfaces of the reflective optical elements, which, on account of their good adhesion on a topmost layer of the optically active surface composed of ruthenium, for example, cannot be cleaned using atomic hydrogen or other cleaning methods and lead to an appreciable reduction of the reflectivity of the optically active surfaces. One possible source of said silicon compounds in the residual gas of an EUV lithography apparatus is the photoresist (resist) on the semiconductor substrate (wafer) to be exposed, from which siloxanes, inter alia, are extracted.

### SUMMARY

Therefore, it an object of the present invention to demonstrate measures for combating contamination by silicon dioxide deposition, hydrocarbon deposition and/or by metal deposition such as are caused e.g. by the interaction of the constituents of the residual gas of a lithography apparatus with EUV radiation and/or by cleaning with atomic hydrogen.

This object is achieved by a reflective optical element for the extreme ultraviolet wavelength range having a reflective surface, wherein the reflective surface has a multilayer coating comprising a topmost layer composed of a fluoride.

It has been found that the metallic contaminants, which can originate from hydrogen cleaning units, for example are, inter alia, zinc, tin, indium, tellurium, antimony, bismuth, lead, arsenic, selenium, germanium, silver, cadmium, mercury, sulfur, gold, copper, tungsten or the alloys thereof. Furthermore, it has been found that the influence of the contamination on the reflectivity by these metals is smaller if the reflective optical element exposed to said contamination has a topmost layer composed of a fluoride. This is because, firstly, such a layer acts as protection of the underlying reflective surface of the optical element against other types of contamination, such as oxidative contamination or carbon contamination, for instance. Secondly, the topmost layer composed of a fluoride has the effect that metallic contaminations adhere to a lesser extent on the topmost layer during operation. This has the advantage that the metallic contaminations can be removed more simply from the surface with cleaning gases, for example. Furthermore, it has been found that this applies equally to contamination layers composed of silicon dioxide, which can also be removed relatively simply with cleaning gases on account of the low adhesion on fluoride layers.

In one embodiment, the multilayer coating of the reflective optical element has below the topmost layer a barrier layer, which prevents the interdiffusion or mixing of the topmost layer with the layers situated underneath. Such a barrier layer preferably consists of at least one material which is selected from the group comprising: silicon nitrides (SiₓN_{y}), silicon oxides (SiₓO_{y}), boron nitride (BN), carbon and carbides, in particular boron carbide (B₄C).

In a further embodiment, the multilayer coating of the reflective optical element has below the topmost layer an interlayer, which protects the reflective optical element against the environmental influences particularly in the case of a small thickness of the topmost layer composed of a fluoride. Such an interlayer preferably consists of at least one material which is selected from the group comprising: molybdenum, ruthenium, noble metals (gold, silver, platinum), silicon, silicon oxides, silicon nitrides, boron carbide, boron nitride, carbon compounds and combinations thereof.

In another embodiment, the barrier layer or the interlayer below the topmost layer composed of a fluoride has a thickness in the range of 0.1 nm to 5 nm. As a result of this, firstly, a sufficient protection of the reflective optical element can be achieved and, secondly, the reflectivity losses arising as a result of the additional layers can be reduced to a minimum amount.

In one embodiment, the multilayer coating of the reflective optical element comprises a multilayer system based on alternating silicon and molybdenum layers or on alternating silicon and ruthenium layers. Such a reflective optical element, particularly in the case of a wavelength of approximately 13.5 nm, can be optimized to the effect that it has particularly high reflectivity values. In this case, in the context of this invention, a multilayer system whose alternating layers are separated by barrier layers for preventing the interdiffusion of the alternating layers is also understood as a multilayer system composed of alternating layers, without this necessitating explicit indications with respect to the barrier layers or the material composition thereof.

In a further embodiment, the topmost layer composed of a fluoride has a thickness in the range of 0.1 nm to 2.5 nm. As a result of this, firstly, the adhesion of the contaminations on the topmost layer, in particular for contaminations composed of silicon dioxide, can be sufficiently reduced and, secondly, the reflectivity losses arising as a result of the topmost layer composed of a fluoride can be reduced to a minimum amount. Furthermore, as a result of this, it is possible to produce a topmost layer which exhibits sufficient long-term stability relative to the environmental influences or relative to the cleaning measures.

In one embodiment, the fluoride of the topmost layer comprises a metal fluoride. Such metal fluorides can be grown in a simple manner by thermal evaporation or by electron beam evaporation on reflective optical elements.

In a further embodiment, the metal fluoride is selected from a group comprising: magnesium fluoride (MgF₂), aluminum fluoride (AlF₃), cryolite (Na₃AlF₆) and chiolite (Na₅Al₃F₁₄). With regard to these metal fluorides, sufficient experience concerning the coating behavior is available, thus resulting in sufficient process reliability for the production of corresponding reflective optical elements. For example, it is known that magnesium fluoride and lanthanum fluorides preferably grow in polycrystalline fashion, whereas aluminum fluoride and chiolite grow rather in amorphous fashion. Consequently, depending on the use or mixture of the metal fluorides, using the coating process parameters, it is possible to establish specific surface properties, such as the microroughness, for example. These fluorides are also harmless from a toxicological stand point so that these fluorides can be handled easily within a coating process.

The object is furthermore achieved by a method for operating an EUV lithography apparatus comprising a reflective optical element having a reflective surface, comprising the following steps:
providing at least one reflective optical element having a reflective surface having a topmost layer composed of a fluoride, and
adding at least one cleaning gas selected from the group comprising atomic hydrogen, molecular hydrogen (H₂), perfluorinated alkanes such as tetrafluoromethane (CF₄), oxygen, nitrogen, argon, krypton and helium.

In this case, the metal contaminations are removed from the topmost layer composed of a fluoride with the aid of atomic hydrogen that reacts with said metals to form volatile hydrides. Contaminations of hydrocarbons are likewise removed from the topmost layer composed of a fluoride using the atomic hydrogen. In this case, the atomic hydrogen can be formed from molecular hydrogen at the reflective surface in interaction with EUV radiation or can already be supplied as atomic hydrogen to the topmost layer. Correspondingly, for example, oxygen can be decomposed at the reflective surface by EUV radiation and can thus be used analogously by way of oxidative processes for the removal of contaminations composed of hydrocarbons from the topmost layer.

Contamination layers composed of silicon dioxide can be removed by reactions with the cleaning gases such as e.g. perfluorinated alkanes, oxygen, nitrogen, argon, krypton and/or helium. In the case of helium, it is also possible here to ignite a plasma for cleaning at the reflective surface. Plasma cleaning can likewise be carried out in the case of the cleaning gases argon, oxygen, nitrogen, krypton, hydrogen or the mixtures thereof.

It has been found that the contaminations mentioned can be removed particularly simply from a reflective surface with cleaning gases when the reflective surface has a topmost layer composed of a fluoride. In particular, contamination layers composed of silicon dioxide can be removed from a reflective surface having a topmost layer composed of a fluoride by the cleaning gases, which contamination layers cannot be removed for example from a reflective surface having a topmost layer composed of ruthenium by the cleaning gases. The reflectivity losses caused by the contaminations can thus be reversed by the removal of the contaminations.

In one embodiment, the supply of the cleaning gas or the cleaning gases is set in such a way that the layer thickness of the topmost layer composed of a fluoride does not change over time, such that the reflective surface is permanently protected against the surroundings.

In another embodiment, the cleaning gas is added as homogeneously as possible over the reflective surface in order to clean the reflective surface uniformly and in order thus to avoid different reflectivity values over the reflective surface. Different reflectivity values over the reflective surface lead to imaging aberrations of the lithography apparatus.

Moreover, the object of the invention is achieved with an EUV lithography apparatus comprising at least one reflective optical element according to the invention.

Furthermore, the object of the invention is achieved through an illumination system and a projection system comprising at least one reflective optical element according to the invention.

### BRIEF DESCRIPTION OF THE FIGURES

The present invention will be explained in greater detail with reference to a preferred exemplary embodiment. For this purpose:

FIG. 1 schematically shows an embodiment of an EUV lithography apparatus comprising an illumination system and a projection system;

FIGS. 2a-c show schematic illustrations of different embodiments of reflective optical elements;

FIGS. 3, 4, 5 show reflectivity values of different embodiments of reflective optical elements plotted against the wavelength; and

FIGS. 6a, 6b show a flowchart concerning two embodiments of the method for operating an EUV lithography apparatus.

### DETAILED DESCRIPTION

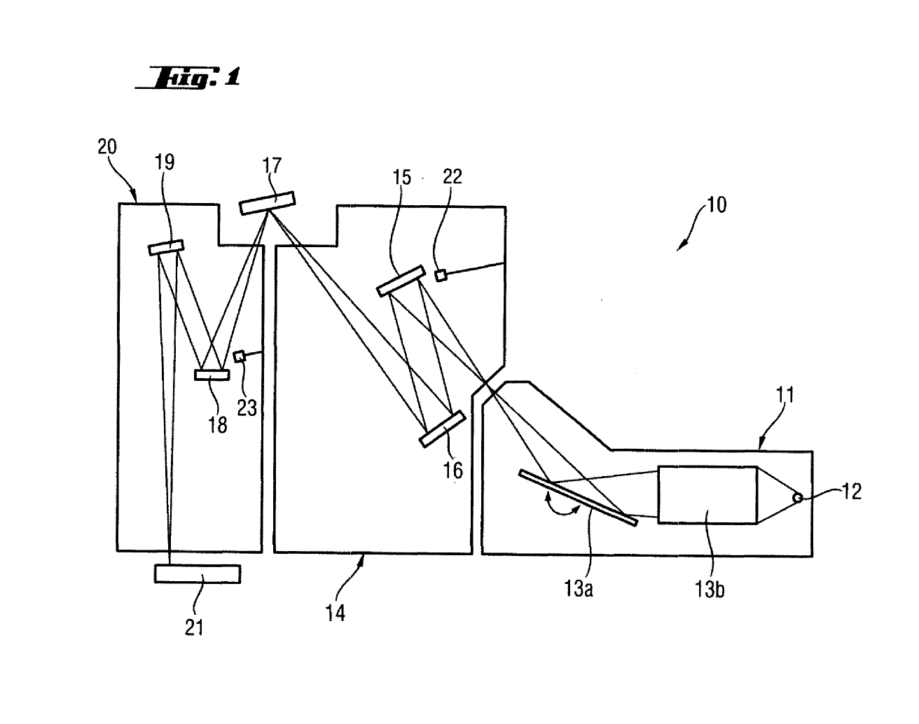

FIG. 1 schematically illustrates an EUV lithography apparatus 10. Essential components are the beam shaping system 11, the illumination system 14, the photomask 17 and the projection system 20. The EUV lithography apparatus 10 is operated under vacuum conditions in order that the EUV radiation is absorbed as little as possible in its interior.

The beam shaping system 11 comprises a radiation source 12, a collimator 13b and a monochromator 13a. By way of example, a plasma source or else a synchrotron can serve as radiation source 12. The emerging radiation in the wavelength range of approximately 5 nm to 20 nm is firstly concentrated in the collimator 13b. In addition, the desired operating wavelength is filtered out with the aid of a monochromator 13a. In the wavelength range mentioned, the collimator 13b and the monochromator 13a are usually embodied as reflective optical elements. In the case of the collimators, a distinction is made between so-called normal-incidence and so-called grazing-incidence collimators, wherein the reflective optical elements of the normal-incidence collimator rely on multilayer coatings in order to ensure a high reflectivity with virtually perpendicular light incidence. Grazing-incidence collimators, which operate with grazing light incidence, are often reflective optical elements embodied in shell-shaped fashion in order to achieve a focusing or collimating effect. The reflection of the radiation with grazing light incidence takes place at the concave surface of the shells of said collimators, wherein, for reflection purposes, it is often the case that no multilayer system is used on the concave surface since a widest possible wavelength range is intended to be reflected. The filtering-out of a narrow wavelength band by reflection therefore takes place at the monochromator, often with the aid of a grating structure or a multilayer system.

The operating beam conditioned with regard to wavelength and spatial distribution in the beam shaping system 11 is then introduced into the illumination system 14. In the example illustrated in FIG. 1, the illumination system 14 has two mirrors 15, 16. The mirrors 15, 16 direct the beam onto the photomask 17, which has the structure that is intended to be imaged onto the wafer 21. The photomask 17 is likewise a reflective optical element for the EUV and soft wavelength range, said element being exchanged depending on the production process. With the aid of the projection system 20, the beam reflected from the photomask 17 is projected onto the wafer 21 and the structure of the photomask is thereby imaged onto said wafer. In the example illustrated, the projection system 20 has two mirrors 18, 19. It should be pointed out that both the projection system 20 and the illumination system 14 can likewise each have just one or else three, four, five or more mirrors.

In order—in the example illustrated here—to clean contamination from the respective first mirrors 15, 18 of the illumination system 14 and projection system 20 in the beam path, cleaning heads 22, 23 are provided. Since the highest radiation load occurs in each case on the first mirror of a module in the beam path, the highest degree of contamination should be expected there particularly in the case of carbon-containing contamination. Alternatively, a cleaning head can also be provided at each mirror. Accordingly, in the case of the mirrors situated near the wafer 21, increased contamination of silicon compounds such as siloxanes, for example, should be expected, which deposit under EUV radiation as silicon dioxide contaminations on the reflective surfaces. Accordingly, similar cleaning heads can be provided at these mirrors, a different cleaning gas or a different mixture of cleaning gases being used in the case of said cleaning heads on account of the different jeopardization situation.

The cleaning heads 22, 23 have a supply for molecular hydrogen, for example, and also an incandescent filament, for example, past which the molecular hydrogen is fed in order to dissociate it into atomic hydrogen by the high temperature of the glowing incandescent filament. The resultant atomic hydrogen is passed, in the vicinity of the mirror 15, 18 to be cleaned, into the residual gas atmosphere of the EUV lithography apparatus 10, preferably directly onto the mirror surface of the mirror to be cleaned in order that it converts carbon-containing contaminations on the mirrors 15, 18 into volatile hydrocarbon compounds. Atomic hydrogen can also arise as a result of the interaction of the EUV radiation used during the operation of the EUV lithography apparatus or ions generated by said radiation with molecular hydrogen contained in the residual gas atmosphere. Furthermore, the atomic hydrogen can also be produced outside the EUV lithography apparatus and subsequently be directed onto the reflective surfaces via the cleaning heads 22, 23.

Correspondingly, other cleaning gases can also be directed homogeneously onto the reflective surfaces with similar cleaning heads and be activated by an incandescent filament, by EUV radiation or by plasma excitation for the cleaning process.

During the operation of the cleaning heads 22, 23, metals, in particular zinc, tin, indium, tellurium, antimony, bismuth, lead, arsenic, selenium, germanium, silver, cadmium, mercury, sulfur, gold, copper, tungsten, or the alloys thereof, can emerge into the residual gas atmosphere or are sputtered out from components within the EUV lithography apparatus 10 such as, for instance, the housing of the cleaning heads 22, 23, the mirror holders, the mirror substrates, contact-connections, etc., by the resulting free hydrogen radicals or other high-energy particles. To a substantial extent they are extracted by the atomic hydrogen present through chemical processes, e.g. in the form of volatile hydrides. Thus, by way of example, zinc or tungsten often originate from the cleaning heads themselves, while tin and indium can originate e.g. from contact-connections such as soldering connections, for instance. These metals can in turn deposit on the optically active surfaces of the reflective optical elements and thereby impair the reflectivity thereof in terms of magnitude and with regard to homogeneity over the emitted range, which leads to transmission losses and to imaging aberrations in the illumination system and in the projection system.

In order to limit the adverse influence of the contaminations mentioned on the reflectivity, reflective optical elements having a topmost layer composed of a fluoride on their reflective surface are used in the EUV lithography apparatus 10.

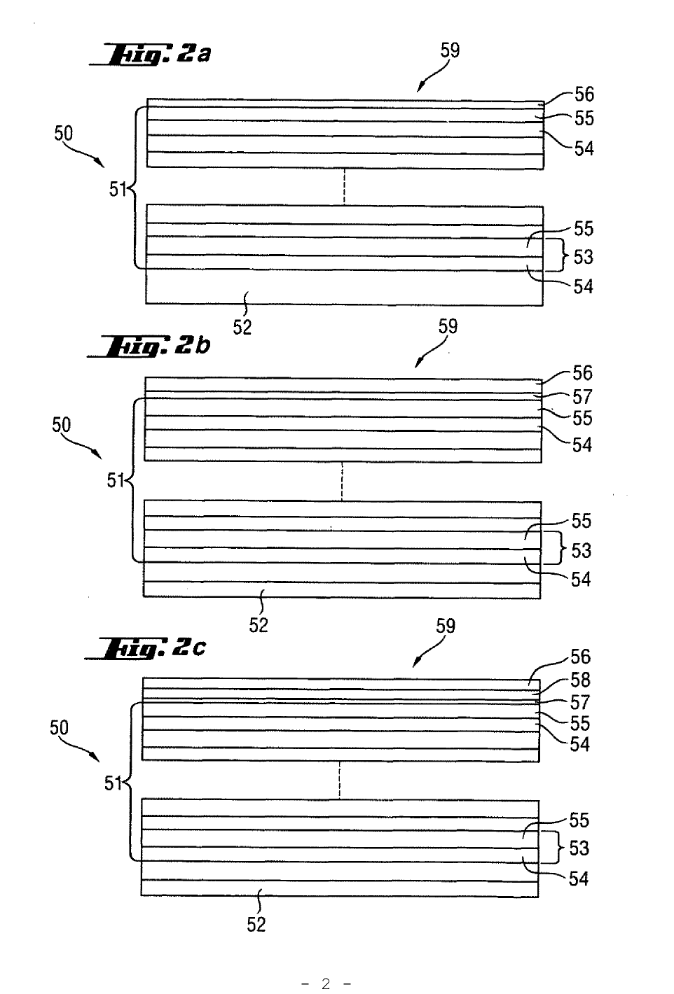

FIGS. 2a-b schematically illustrate the structure of exemplary embodiments of such reflective optical elements 50. The examples illustrated involve reflective optical elements based on a multilayer system 51. This involves alternately applied layers of a material having a higher real part of the refractive index at the operating wavelength (also called spacer 55), and of a material having a lower real part of the refractive index at the operating wavelength (also called absorber 54), an absorber-spacer pair forming a stack 53. In this case, the terms higher real part and lower real part of the refractive index are relative terms relative to the respective partner material within an absorber-spacer pair. The sequence of absorber-spacer pairs to a certain extent simulates a crystal whose network planes correspond to the absorber layers at which Bragg reflection takes place. The thicknesses of the individual layers 54, 55 and also of the repeating stacks 53 can be constant or else vary over the entire multilayer system 51, depending on which reflection profile is intended to be achieved. The reflection profile can also be influenced in a targeted manner by the basic structure composed of absorber 54 and spacer 55 being supplemented by further, more and less absorbent materials in order to increase the maximum possible reflectivity at the respective operating wavelength. For this purpose, in some stacks, absorber and/or spacer materials can be interchanged or the stacks can be constructed from more than one absorber material and/or spacer material. The absorber and spacer materials can have constant or else varying thicknesses over all the stacks in order to optimize the reflectivity.

The multilayer system 51 is applied on a substrate 52 and is a constituent part of the multilayer coating of the reflective surface 59. Materials having a low coefficient of thermal expansion are preferably chosen as substrate materials. Glass ceramics, for example, are suitable. However, they can likewise be a source of contamination under EUV irradiation or, in particular, under the influence of atomic hydrogen used for cleaning the optical surface.

A topmost layer composed of a fluoride is applied as protective layer 56 on the reflective surface 59. The topmost layer 56 is preferably applied during the production of the reflective optical element 50. This ensures that the topmost layer 56 continuously covers the complete reflective surface 59 or at least that region of the reflective surface 59 from which reflection takes place during use, in order to avoid inhomogeneities over the surface. Moreover, a specific thickness of the topmost layer 56 can be set in a targeted manner, which already exerts a protective effect without the reflectivity being impaired too much. Methods that use thermal evaporation, electron beams, magnetron sputtering or ion beam sputtering are particularly suitable for producing such reflective optical elements.

FIG. 2a illustrates an embodiment wherein the topmost layer composed of a fluoride is applied directly on the final layer of the multilayer system 51, a spacer layer 55 in the present example. However, in the case of some material combinations it can happen that, at the boundary layer between the topmost layer 59 and the underlying final layer of the multilayer system 51, diffusion or chemical reactions occur. These alter the construction and the thicknesses in this region of the multilayer system in such a way that the reflectivity is thereby worsened, in particular the reflectivity decreases over the lifetime of the reflective optical element 50. In order to counteract that, in the embodiment illustrated in FIG. 2b, an additional layer 57 is provided as a diffusion barrier and/or protection against chemical reactions. Such barrier layers can, moreover, also be provided within the multilayer system 51 between individual layers or stacks in order that the reflectivity does not decrease over time on account of structural alterations. In particular carbon, boron carbide, carbides generally, silicon nitrides or silicon oxides are appropriate as materials of such diffusion barriers.

The variant illustrated in FIG. 2c involves an embodiment wherein an interlayer 58 composed of a material such as is usually used as a protective layer for multilayer-based reflective optical elements is provided between the topmost layer composed of a fluoride. This has the advantage that, in the case of a very thin fluoride layer, the underlying multilayer system is nevertheless still permanently protected in the event of alteration or wear of the fluoride layer. For example with the use of molybdenum as absorber and silicon as spacer, a silicon surface, in particular, is jeopardized since the silicon can be converted into silanes by the atomic hydrogen. In particular molybdenum, ruthenium, noble metals such as gold, silver or platinum, silicon, silicon oxides, silicon nitrides, boron carbide, boron nitride or carbon compounds are appropriate as materials of such protective layers.

Moreover, the reflectivity can be increased somewhat given a suitable choice of the material for the interlayer 58. In the example illustrated, moreover, a barrier layer 57 against diffusion and/or chemical reactions is provided between the interlayer 58 and the multilayer system 51.

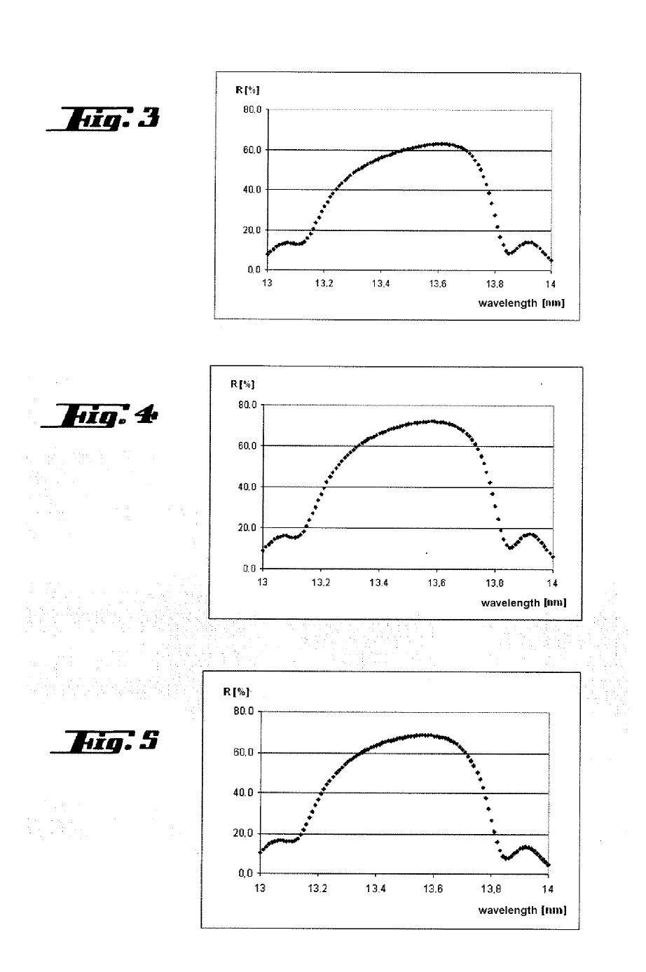

FIGS. 3, 4 and 5 show reflectivity values in the unit [%] plotted against the wavelength in the unit [nm] for three different embodiments of a mirror according to the invention, having in each case a topmost layer 56 composed of MgF₂ having a thickness of 2 nm in accordance with FIGS. 2a and 2c. In this case, the three embodiments in FIGS. 3, 4 and 5 differ merely in the layers between the multilayer system 51 and the topmost layer 56 composed of MgF₂.

The multilayer system 51 with regard to FIGS. 3, 4 and 5 consists of 50 periods of alternating silicon and molybdenum layers, a silicon layer being 3.78 nm thick and a molybdenum layer being 2.37 nm thick, and the silicon and molybdenum layers being separated from one another by boron carbide layers as diffusion barriers having a thickness of 0.4 nm in each case. In this case, the multilayer system 51 with regard to FIGS. 3, 4 and 5 is applied on a thin quartz layer having a thickness of 4 nm, which serves as a polishing layer on the substrate 52 in order to improve the surface roughness. Alternatively, it is also possible to dispense with this polishing layer composed of quartz in accordance with FIGS. 2a and 2c, in which the multilayer system 51 is applied directly on the substrate 52. On account of the polishing layer composed of quartz, the multilayer system 51 with regard to FIGS. 3, 4 and 5 begins with a silicon layer as spacer layer 55 above the substrate and ends with a boron carbide layer as diffusion barrier on a molybdenum layer as absorber layer 54.

In accordance with the exemplary embodiment with regard to FIG. 3, a spacer layer 55 composed of silicon having a thickness of 1.4 nm, an absorber layer 54 composed of molybdenum having a thickness of 2 nm, an interlayer 58 composed of ruthenium having a thickness of 1.5 nm and a final topmost layer 56 composed of MgF₂ having a thickness of 2 nm are applied in the order specified here on said multilayer system 51. Accordingly, the exemplary embodiment with regard to FIG. 3 constitutes a variant of an exemplary embodiment in accordance with FIG. 2c with regard to the topmost layer 56 composed of a fluoride on an interlayer 58 as protective layer. The exemplary embodiment with regard to FIG. 3 affords a maximum reflectivity of 63% at a wavelength of 13.6 nm. Furthermore, the reflectivity values in FIG. 3 lie above 60% for wavelengths of between 13.5 nm and 13.7 nm.

In accordance with the exemplary embodiment with regard to FIG. 4, a spacer layer composed of silicon having a thickness of 3.5 nm and a final topmost layer 56 composed of MgF₂ having a thickness of 2 nm are applied on the multilayer system 51. Accordingly, the exemplary embodiment with regard to FIG. 4 constitutes a variant of an exemplary embodiment in accordance with FIG. 2a with regard to the topmost layer 56 composed of a fluoride on a spacer layer 55. The exemplary embodiment with regard to FIG. 4 affords a maximum reflectivity of 72% at a wavelength of 13.6 nm. Furthermore, the reflectivity values in FIG. 4 lie above 60% for wavelengths of between approximately 13.3 nm and 13.7 nm.

In accordance with the exemplary embodiment with regard to FIG. 5, a spacer layer composed of silicon having a thickness of 1.7 nm, an absorber layer 54 composed of molybdenum having a thickness of 2 nm, and a final topmost layer 56 composed of MgF₂ having a thickness of 2 nm are applied on the multilayer system 51. Accordingly, the exemplary embodiment with regard to FIG. 5 constitutes a variant of an exemplary embodiment with regard to the topmost layer 56 composed of a fluoride on an absorber layer 54. The exemplary embodiment with regard to FIG. 5 affords a maximum reflectivity of 68% at a wavelength of 13.6 nm. Furthermore, the reflectivity values in FIG. 5 lie above 60% for wavelengths of between 13.4 nm and 13.7 nm.

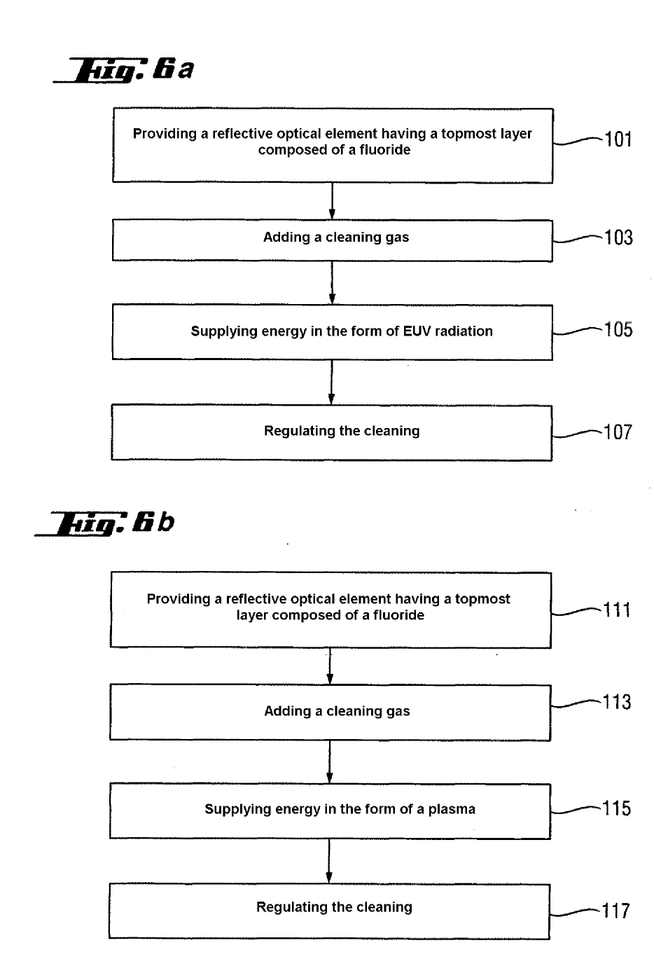

The use of the reflective optical elements explained here in an EUV lithography apparatus will be explained in greater detail in association with FIGS. 6a and 6b, which schematically illustrate two embodiments of methods for operating EUV lithography apparatuses comprising such reflective optical elements.

A first step 101, 111 involves firstly providing at least one reflective optical element having a topmost layer composed of a fluoride in a lithography apparatus.

A further step 103, 113 involves adding a cleaning gas, for instance with the aid of a cleaning unit for example in the form of a cleaning head. In this case, care is taken to ensure that the cleaning gas is added as homogeneously as possible over the reflective surface in order that as far as possible no inhomogeneities arise on the topmost layer composed of a fluoride in the event of the reaction of the contaminations with the cleaning gas to form volatile compounds such as hydrides, for example.

In a third step 105, in the embodiment in accordance with FIG. 6a, the cleaning gas is activated at the surface of the reflective surface by the supply of energy in the form of EUV radiation in such a way that it can react with the contaminations on the reflective surface. This type of activation is conceivable for example for the cleaning gases molecular hydrogen and oxygen. By contrast, as already explained further above in association with the cleaning heads 22 and 23, atomic hydrogen can be produced either by an incandescent filament in the cleaning heads or in some other way outside the lithography apparatus.

In the embodiment in accordance with FIG. 6b, this third step 115 for activating the cleaning gas at the reflective surface is realized by igniting a plasma. In this case, in the design of the electrodes for feeding in the high-frequency electromagnetic radiation for operating the plasma, care should be taken to ensure that the plasma is distributed as uniformly as possible over the reflective surface. This can be realized using a corresponding electrode design, for example.

This form of activation is advantageous for the cleaning gas helium, in particular, since contaminations of silicon dioxide can thereby be removed very rapidly from a topmost layer composed of a fluoride of the reflective optical element.

A fourth step 107, 117 involves regulating the addition of the cleaning gas 103, 113 and the supply of energy for activating the cleaning gas 105, 115 in such a way that, on the one hand, the contaminations on the reflective surface are removed from the reflective surface to a desired degree of cleaning and, on the other hand, the topmost layer of the reflective surface is attacked by the cleaning itself only as far as a desired long-term stability of the reflective optical element is ensured even in the case of repeating cleaning cycles.

A further possibility for the operation of an EUV lithography apparatus consists in adding the cleaning gas from time to time during normal exposure operation, e.g. if the reflectivity falls below a predetermined threshold value.

Another possibility consists in setting the addition of cleaning gas in such a way that approximately one monolayer forms as contamination layer on the topmost layer composed of a fluoride, which protects the topmost layer composed of a fluoride.

The above description has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. Reflective optical element configured to reflect radiation having wavelengths in the extreme ultraviolet range comprising a reflective surface, wherein the reflective surface has a multilayer coating comprising a topmost layer composed of a metal fluoride, wherein the metal fluoride is selected from the group consisting of: aluminum fluoride, cryolite and chiolite.

2. Reflective optical element according to claim 1, wherein the multilayer coating has, below the topmost layer, an interlayer composed of at least one material which is selected from the group consisting of: molybdenum, ruthenium, noble metals, silicon, silicon oxides, silicon nitrides, boron carbide, boron nitride, carbon compounds and combinations thereof.

3. Reflective optical element according to claim 2, wherein the interlayer below the topmost layer has a thickness in the range of approximately 0.1 nm to 5 nm.

4. Reflective optical element according to claim 1, wherein the multilayer coating has, below the topmost layer, a barrier layer composed of at least one material which is selected from the group consisting of: silicon nitrides, silicon oxides, boron nitride, carbon, carbides, and boron carbide.

5. Reflective optical element according to claim 4, wherein the barrier layer below the topmost layer has a thickness in the range of approximately 0.1 nm to 5 nm.

6. Reflective optical element according to claim 1, wherein the multilayer coating of the reflective surface comprises a multilayer system, the multilayer system comprising alternating silicon and molybdenum layers 4) or alternating silicon and ruthenium layers.

7. Reflective optical element according to claim 1, wherein the topmost layer has a thickness in the range of approximately 0.1 nm to 2.5 nm.

8. Method for operating an EUV lithography apparatus comprising a reflective optical element having a reflective surface, comprising:
providing at least one reflective optical element having a reflective surface according to claim 1, and
adding at least one cleaning gas, selected from the group consisting of atomic hydrogen, molecular hydrogen, perfluorinated alkanes, oxygen, nitrogen, argon, krypton and helium.

9. Method for operating an EUV lithography apparatus according to claim 8, further comprising:
supplying energy to activate the cleaning gas, wherein the energy is at least one of: radiation in the extreme ultraviolet wavelength range and an ignited plasma.

10. Method according to claim 8, wherein the addition of the cleaning gas is set such that the layer thickness of the topmost layer composed of a fluoride of the reflective optical element remains substantially constant.

11. Method according to claim 8, wherein the cleaning gas is added substantially homogeneously over the reflective surface.

12. A lithography apparatus configured for operation in an extreme ultraviolet wavelength range, comprising a reflective optical element according to claim 1.

13. An illumination system configured for a lithography apparatus and comprising a reflective optical element according to claim 1.

14. A projection system configured for a lithography apparatus and comprising a reflective optical element according to claim 1.
